(19) United States
(12) Patent Application Publication
(10) Pub. No.: US 2025/0324951 A1
(43) Pub. Date: Oct. 23, 2025

(54) METHOD FOR RESTORING FISH HABITAT WATER FLOW STRUCTURE

(71) Applicant: China Institute of Water Resources and Hydropower Research, Beijing (CN)

(72) Inventors: WEI HUANG, Beijing (CN); JINJIN GE, Beijing (CN); MIN ZHANG, Beijing (CN); XIAOBO LIU, Beijing (CN); ZHUOWEI WANG, Beijing (CN); WEIJIE WANG, Beijing (CN); XIAODONG QU, Beijing (CN); HAIPING ZHANG, Beijing (CN); YANG YU, Beijing (CN); YING XIE, Beijing (CN)

(21) Appl. No.: 18/807,928

(22) Filed: Aug. 17, 2024

(30) Foreign Application Priority Data
Apr. 19, 2024 (CN) 202410471387.2

(51) Int. Cl. A01K 61/95; A01K 61/70

(52) U.S. Cl. CPC A01K 61/95; A01K 61/70

(57) ABSTRACT

A method for restoring a fish habitat water flow structure, including step 1: obtaining water body information and dividing a to-be-restored water area to obtain a plurality of investigation areas based on the water body information, by a water body information management unit; step 2: sampling and shooting aquatic organisms at a target location in the investigation areas by a shooting device of an aquatic organism investigation unit so as to obtain an aquatic organism sampling map, obtaining fish information in the water body based on the aquatic organism sampling map, by the aquatic organism investigation unit; step 3: selecting an optimal restoration plan for the fish habitat water flow structure based on fish information and water body information, by a habitat selection unit; step 4: restoring the target water area according to the optimal restoration plan, by a habitat restoration unit.

### CROSS-REFERENCE TO RELATED APPLICATIONS

This application claims priority to Chinese Patent Application No. 202410471387.2, filed on Apr. 19, 2024, which is hereby incorporated by reference in its entirety.

### TECHNICAL FIELD

The present disclosure relates to the field of environmental reconstruction technologies, and in particular, to a method for restoring a fish habitat water flow structure.

### BACKGROUND

In natural or artificial environments with large water level differences and unstable water flow, it is difficult for fish schools to seek refuge and survive, including critical life processes such as foraging and spawning.

In order to ensure the gathering and survival of fish schools, it is often necessary to carry out ecological improvement and restoration in specific areas. However, when carrying out ecological improvement and restoration in specific areas, due to a lack of data information on fish and other organisms, the results of ecological environment improvement cannot adapt well to the situation of fish schools.

Therefore, problems in the existing technology need further improvement and development.

### SUMMARY

The present disclosure aims at solving the problems existing in the prior art mentioned above, a purpose of the present disclosure is to provide a method for restoring a fish habitat water flow structure.

In order to solve the above technical problems, this technical solution provides a method for restoring a fish habitat water flow structure, the method is applied to a fish habitat water flow structure restoration system, the system includes an aquatic organism investigation unit, a water body information management unit, a habitat selection unit, a habitat restoration unit, and a display unit, and the method includes the following steps:
step 1: obtaining water body information and dividing a to-be-restored water area to obtain a plurality of investigation areas based on the water body information, by the water body information management unit;
step 2: sampling and shooting aquatic organisms at a target location in the investigation areas so as to obtain an aquatic organism sampling map, by a shooting device of the aquatic organism investigation unit; obtaining fish information in the water body based on the aquatic organism sampling map, by the aquatic organism investigation unit;
step 3: selecting an optimal restoration plan for the fish habitat water flow structure based on fish information and water body information, by the habitat selection unit;
step 4: restoring the target water area according to the optimal restoration plan, by the habitat restoration unit.

In an embodiment of the present disclosure, the water information management unit includes a collection device and/or a crawling device; there are a plurality of collection devices, they are respectively provided at different positions in the to-be-restored water area and configured to obtain the water information of the to-be-restored water area; the crawling device obtains the water body information of the to-be-restored water area in the Internet of Things based on name and/or location of the to-be-restored water area; where the water body information includes an overall volume V of the to-be-restored water area, as well as a corresponding water volume, water flow velocity, and water depth at different locations;
the water information management unit divides the to-be-restored water area into a plurality of investigation areas based on the water information, and a water volume of each investigation area is represented by V2; the number of the investigation areas is represented by i, i is a positive integer greater than or equal to 1.

In an embodiment of the present disclosure, the aquatic organism investigation unit includes a plurality of shooting devices configured to shoot aquatic organisms, and the shooting devices are provided at different target positions in different investigation areas; the number x of the shooting devices is a multiple of the number i of the investigation areas, the multiple is a first multiple z, and the first multiple z is a positive integer greater than or equal to 2.

In an embodiment of the present disclosure, step 2 includes the following substeps:
step 21: collecting an aquatic organism sampling map for each target location in each investigation area, by the shooting device of the aquatic organism investigation unit;
step 22: conducting graphical analysis on the aquatic organism sampling map by the aquatic organism investigation unit to obtain fish species and fish quantity in each aquatic organism sampling map;
step 23: obtaining the fish species and fish quantity in each investigation area with a threshold value method, by the aquatic organism investigation unit;
step 24: summing up the number of fish for different species in all investigation areas by the aquatic organism investigation unit, and obtaining a corresponding number of fish for different species in the to-be-restored water area.

In an embodiment of the present disclosure, in step 21, when providing with the shooting device in the investigation area, a corresponding marker is provided at an investigation area corresponding to each shooting device; the number of the shooting device in each investigation area is z, z is equal to a water depth stratification/water flow zone a of a current investigation area;
the fish habitat water flow structure restoration system is provided with a water volume V1 of the target location for collecting the aquatic organism sampling map when the shooting device collecting the aquatic organism sampling map; the water body information management unit, based on the marker of the shooting device corresponding to each aquatic organism sampling map, reads a volume V2 of the investigation area corresponding to an investigation area where the corresponding shooting device is located.

In an embodiment of the present disclosure, the step 23 includes: calculating the number N′ of fish for different species in the current investigation area according to a relationship between the number n of fish for different species at the target location in each investigation area with the water volume V1 of the target location and the water volume V2 of the investigation area, by the aquatic organism investigation unit; and a calculation formula is as follows:

$${N}^{′} = {\sum }_{m = 1}^{z} \frac{V {1}_{m}}{{n}_{m}} * \frac{V 2}{z} .$$

In an embodiment of the present disclosure, in step 24, the aquatic organism investigation unit calculates the number N of fish for different species in the to-be-restored water area based on the number of fish for different species in all investigation areas, and a calculation formula is as follows:

$$N = {\sum }_{k = 1}^{i} {N}_{k}^{′} .$$

In an embodiment of the present disclosure, the habitat selection unit includes restoration plans for habitats corresponding to different fish species, different fish species has restoration plans for the fish species with different numbers;
the step 3 includes:
step 31: selecting a restoration plan corresponding to this fish species in the water area from the restoration plan of habitats for different fish species based on fish species and a total number of this fish species in the to-be-restored water area, by the habitat selection unit;
step 32: combining the restoration plan corresponding to each fish species to obtain the optimal restoration plan, by the habitat selection unit.

In an embodiment of the present disclosure, the aquatic organism investigation unit collects fish information for different time periods, estimates fish information in a future time period based on the collected fish information for different time periods, and selects the optimal restoration plan, by the habitat selection unit;
and the step 2 is that the shooting device samples and shoots aquatic organisms at the target location in the investigation area at a specified time period. After obtaining aquatic organism sampling map in a plurality of specified time periods, the aquatic organism investigation unit obtains fish information in the water body at the specified time period based on the aquatic organism sampling map.

In an embodiment of the present disclosure, the aquatic organism investigation unit calculates a value of a first target parameter in a first calculation formula based on the number N of fish for different species in the to-be-restored water area at each specified time period in the sampling set, the aquatic organism investigation unit calculates a value of a second target parameter in a second calculation formula based on the number N of fish for different species in the to-be-restored water area at each specified time period in the sampling set, the aquatic organism investigation unit inputs values of the first target parameter and the second target parameter into a third calculation formula to calculate the number N″ of fish for different species in the further T^{th} time period;
the first calculation formula is defined to describe a relationship between the number N of fish for different species in different time periods, and a specific expression is Yₜ=C+φ₁Yₜ₋₁+φ₂Yₜ₋₂+K+φₚY₁₋ₚ+ξₜ; Yₜ is an observation value of the number of fish for different species in a time period t, where c is a constant, φ is an autoregressive coefficient, and ξₜ is an error term; the constant c, autoregressive coefficient φ, and error term ξₜ are the first target parameters;
the second calculation formula is defined to describe a relationship between data at a current time point and a past noise, and a specific expression is Yₜ=μ+εₜ+θ₁εₜ₋₁+θ₂εₜ₋₂+Λ+θ_{q}ε_{t-q}; Yₜ is a time series of interested, and the observation value at the time point t is an observation value of the number of fish for different species at the time period t; μ is a mean or expected value of the time series, which is the same for all time points; θ is a parameter of the second calculation formula, and each parameter θ corresponds to a white noise term, which measures an influence degree of a corresponding white noise on the current time point, εₜ is the white noise term; and the parameter θ and white noise term εₜ are the second target parameters;
the third calculation formula is: Yₜ=C+φ₁Yₜ₋₁+φ₂Yₜ₋₂+K+φₚYₜ₋ₚ+εₜ+θ₁εₜ₋₁+θ₂εₜ₋₂+Λ+θ_{q}ε_{t-q}; Yₜ is the time series of interested, a calculation value at the time point t is an estimated value of the number N″ of fish for different species in the future time period t.

Beneficial effects of the present disclosure: the present disclosure provides a method for restoring a fish habitat water flow structure, the water area was divided into investigation areas based on water flow and depth, and shooting device is provided to collect aquatic organism sampling map in each investigation area based on water depth and/or water flow conditions, thereby accurately estimating the fish information of an entire to-be-restored water area, and selecting an optimal restoration plan based on the fish information of the entire to-be-restored water area, ensuring an accuracy of the optimal restoration plan, avoiding insufficient fish habitat caused by fish reproduction and other reasons, and also avoiding the problem of excessive repair range and resource waste.

### BRIEF DESCRIPTION OF DRAWINGS

FIG. 1 is a step schematic diagram of a method for restoring a fish habitat water flow structure in an embodiment of the present disclosure.

FIG. 2 is a step schematic diagram of a method for restoring a fish habitat water flow structure in another embodiment of the present disclosure.

### DESCRIPTION OF EMBODIMENTS

The following provides a further detailed explanation of the present disclosure in combination with preferred embodiments. More details are provided in the following description to facilitate a full understanding of the present disclosure. However, it is obvious that the present disclosure can be implemented in various other ways different from this description. Those skilled in the art can make similar promotions and deductions based on an actual application situation without violating a connotation of the present disclosure. Therefore, the protection scope of the present disclosure should not be limited by the content of this specific embodiment.

The attached drawings are schematic diagrams of embodiments of the present disclosure. It should be noted that the drawings are only used as an example and are not drawn according to a proportional condition, and should not be used as a limitation on an actual protection scope of the present disclosure.

A method for restoring a fish habitat water flow structure, the method is applied to a fish habitat water flow structure restoration system, the method includes selecting an optimal fish habitat, providing an optimal restoration plan for fish habitat water flow structure based on fish species and fish quantity and restoring the fish habitat.

The fish habitat water flow structure restoration system includes an aquatic organism investigation unit, a water body information management unit, a habitat selection unit, a habitat restoration unit, and a display unit. The aquatic organism investigation unit is configured to obtain fish information in water body, including fish species and fish quantity. The water information management unit is configured to obtain water information, including water volume, water flow velocity, water depth, etc. The habitat selection unit selects an optimal restoration plan for fish habitats water flow structure based on fish information and water body information. The habitat restoration unit restores a target water body according to the optimal restoration plan. The display unit is configured to display fish information, water body information, and the optimal restoration plan.

Below is a detailed explanation of an embodiment of the method for restoring a fish habitat water flow structure provided by the present disclosure.

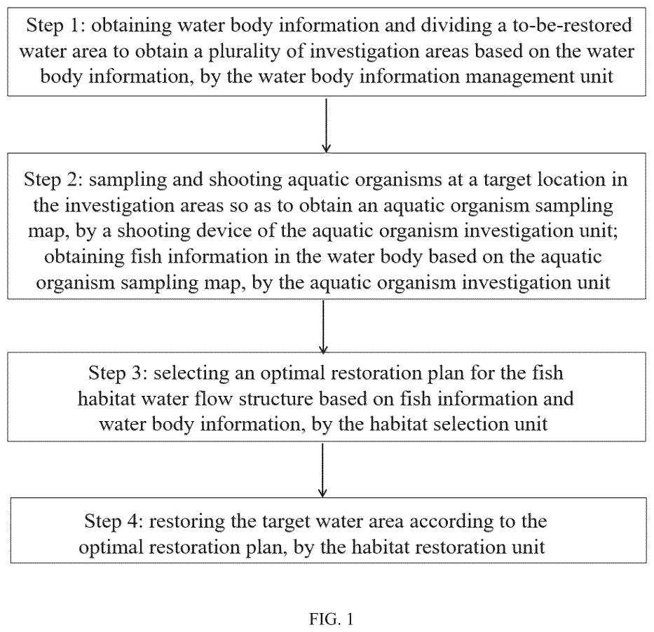

The method for restoring a fish habitat water flow structure, as shown in FIG. 1, including the following steps:
step 1: obtaining water body information and dividing a to-be-restored water area to obtain a plurality of investigation areas based on the water body information, by the water body information management unit;
step 2: sampling and shooting aquatic organisms at a target location in the investigation areas so as to obtain an aquatic organism sampling map, by a shooting device of the aquatic organism investigation unit; obtaining fish information in the water body based on the aquatic organism sampling map, by the aquatic organism investigation unit;
step 3: selecting an optimal restoration plan for the fish habitat water flow structure based on fish information and water body information, by the habitat selection unit;
step 4: restoring the target water area according to the optimal restoration plan, by the habitat restoration unit.

The step 3 further includes displaying the fish information, water body information, and optimal restoration plan by the display unit, for a responsible person to adjust the optimal restoration plan.

In step 1, the water information management unit includes a collection device and/or an information crawling device; there are a plurality of collection devices, they are respectively provided at different positions in the to-be-restored water area and configured to obtain the water information of the to-be-restored water area; the crawling device obtains the water body information of the to-be-restored water area in the Internet of Things based on name and/or location of the to-be-restored water area; the water body information obtained by the collection device and/or the crawling device includes an overall volume V of the to-be-restored water area, as well as a corresponding water volume, water flow velocity, and water depth at different locations.

The water information management unit divides the to-be-restored water area into a plurality of investigation areas based on the water information, the water volume of every investigation area is different, and is represented by V2. The number of the investigation areas is represented by i, i is a positive integer greater than or equal to 1. In an implementation, the water information management unit conducts a regional division on the to-be-restored water area based on the water flow velocity and water depth in the water information; in a same investigation water area, a maximum water flow velocity difference is less than or equal to a first water flow threshold, that is, a difference between a maximum water flow velocity and a minimum water flow velocity is less than or equal to the first water flow threshold; a maximum water depth difference is less than or equal to a first depth threshold, that is, a difference between a maximum water depth and a minimum water depth is less than or equal to the first depth flow threshold. The first water flow threshold and the first depth threshold are preset values, can be set according to an actual situation, or be modify an input unit of the fish habitat water flow structure restoration system. In addition, it should be noted that, if water flow velocity differences in two investigation areas are less than or equal to the first water flow threshold, water depth differences are less than or equal to the first depth threshold, and the two investigation areas are not adjacent, then the two investigation areas are two different investigation areas; and when the two investigation areas are adjacent, the two investigation areas are merged into one investigation area.

The fish information at least includes fish species and fish quantity.

In step 2, the aquatic organism investigation unit includes a plurality of shooting devices for sampling aquatic organisms. The shooting devices are provided at different target positions in different investigation areas, and the aquatic organisms at these positions are sampled and shoot so as to obtain the aquatic organism sampling map. The aquatic organism investigation unit estimates fish species and fish quantity in the to-be-restored water area based on the aquatic organism sampling map collected by the plurality of shooting devices. The number x of the shooting devices is a multiple of the number i of the investigation areas, the multiple is a first multiple z, and the first multiple z is a positive integer greater than or equal to 2, that is, the number x of shooting devices is z*i.

The shooting devices are provided in every investigation area, and the number of the shooting devices in every investigation area is equal to a value of the first multiple. Shooting position of the shooting device in a same investigation area can be placed at the target position according to the water depth, or placed at the target position according to the water flow velocity. There are no specific requirements here, and the operator can also adjust according to the situation of the to-be-restored water area.

The obtaining fish information in the water body by the aquatic organism investigation unit includes the following steps:
step 21: collecting an aquatic organism sampling map for each target location in each investigation area, by the shooting device of the aquatic organism investigation unit;
step 22: conducting graphical analysis on the aquatic organism sampling map by the aquatic organism investigation unit to obtain fish species and fish quantity in each aquatic organism sampling map;
step 23: obtaining the fish species and fish quantity in each investigation area with a threshold value method by the aquatic organism investigation unit;
step 24: summing up the number of fish for different species in all investigation areas by the aquatic organism investigation unit, and obtaining a corresponding number of fish for different species in the to-be-restored water area.

In step 21, when each target location in the investigation area is selected according to the water depth, the aquatic organism investigation unit divides the water depth in the current investigation area into a water depth stratifications, and a value of a is equal to the value of the first multiple; depths of the a water depth stratifications are equal to a water depth of the current investigation area; the shooting device in each investigation area is placed at different water depth stratifications corresponding to the current investigation area based on the divided a water depth stratifications and collect the aquatic organism sampling map at the current target location.

When each target location in the investigation area is selected according to the water flow velocity, the aquatic organism investigation unit divides the water flow velocity in the current investigation area into a water flow zones, and a value of a is equal to the value of the first multiple; a flow velocity interval of the a water flow zones is equal to a flow velocity interval of the current investigation area; the shooting device in each investigation area is placed in the water flow zones with different water flow velocities corresponding to the current investigation area based on the divided a water flow zones so as to collect the aquatic sampling map for the current target location.

When providing with the shooting device in the investigation area, a corresponding marker is provided at an investigation area corresponding to each shooting device; the number of the shooting device in each investigation area is z, z is equal to the water depth stratification/water flow zone a of the current investigation area.

The fish habitat water flow structure restoration system is provided with a water volume V1 of the target location for collecting the aquatic organism sampling map when the shooting device collecting the aquatic organism sampling map; the water body information management unit, based on the marker of the shooting device corresponding to each aquatic organism sampling map, reads a volume V2 of the investigation area corresponding to an investigation area where the corresponding shooting device is located.

In step 23, the obtaining the fish species and fish quantity in each investigation area with a threshold value method includes the following:
calculating the number N′ of fish for different species in the current investigation area according to a relationship between the number n of fish for different species at the target location in each investigation area with the water volume V1 of the target location and the water volume V2 of the investigation area, by the aquatic organism investigation unit; and a calculation formula is as follows:

$${N}^{′} = {\sum }_{m = 1}^{z} \frac{V {1}_{m}}{{n}_{m}} * \frac{V 2}{z} .$$

m represents a target location of a N^{th} shooting device in the same investigation area.

In step 24, the calculating a total number N of fish for all fish species in the to-be-restored water area based on the number of fish species in all investigation areas by the aquatic organism investigation unit is achieved by a calculation formula as following:

$$N = {\sum }_{k = 1}^{i} {N}_{k}^{′} .$$

K represents a N^{th} investigation area where the same fish species are located.

The habitat selection unit includes restoration plans for habitats corresponding to different fish species, different fish species has restoration plans for the fish species with different numbers. Specifically, the restoration plan includes an optimal restoration area and material for different fish species with different numbers, as well as the water depth and water flow velocity for the habitats corresponding to different fish species.

The step 3 specifically includes:
step 31: selecting a restoration plan corresponding to this fish species in the water area from the restoration plan of habitats for different fish species based on fish species and a total number of this fish species in the to-be-restored water area, by the habitat selection unit;
step 32: combining the restoration plan corresponding to each fish species to obtain the optimal restoration plan, by the habitat selection unit.

In step 32, the combining the restoration plans corresponding to each fish species is to directly place the restoration plan corresponding to each fish in the optimal restoration plan.

In step 4, the habitat restoration unit selects the target water area, i.e., the optimal restoration location, based on the restoration plan corresponding to each fish in the optimal restoration plan, as well as the water information of the to-be-restored water area or different investigation areas, and adopts the optimal restoration plan to restore the to-be-restored water area in the target water area.

At this point, the present disclosure provides a method for restoring a fish habitat water flow structure, the water area was divided into investigation areas based on water flow and depth, and shooting device is provided to collect aquatic organism sampling map in each investigation area based on water depth and/or water flow conditions, thereby accurately estimating the fish information of an entire to-be-restored water area, and selecting an optimal restoration plan based on the fish information of the entire to-be-restored water area, ensuring an accuracy of the optimal restoration plan, avoiding insufficient fish habitat caused by fish reproduction and other reasons, and also avoiding the problem of excessive repair range and resource waste.

The following is a detailed explanation of another embodiment of a method for restoring a fish habitat water flow structure provided by the present disclosure.

In the method for restoring a fish habitat water flow structure, the aquatic organism investigation unit can collect fish information for different time periods, estimate fish information in a further time period based on the collected fish information for different time periods, and select an optimal restoration plan by the habitat selection unit. At this point, the shooting device samples and captures aquatic organisms at a target location in the investigation area at a specified time period. After obtaining aquatic organism sampling maps for a plurality of specified time periods, the aquatic organism investigation unit obtains fish information in the water body in a specified time period based on the aquatic organism sampling map.

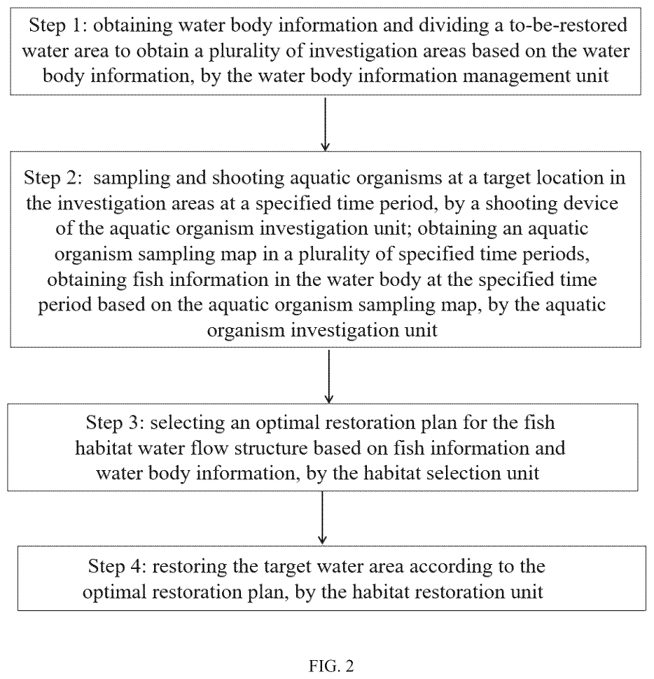

As shown in FIG. 2, it specifically includes the following steps:
step 1: obtaining water body information and dividing a to-be-restored water area to obtain a plurality of investigation areas based on the water body information, by the water body information management unit;
step 2: sampling and shooting aquatic organisms at a target location in the investigation areas at a specified time period, by a shooting device of the aquatic organism investigation unit; obtaining an aquatic organism sampling map in a plurality of specified time periods, obtaining fish information in the water body at the specified time period based on the aquatic organism sampling map, by the aquatic organism investigation unit;
step 3: selecting an optimal restoration plan for the fish habitat water flow structure based on fish information and water body information, by the habitat selection unit;
step 4: restoring the target water area according to the optimal restoration plan, by the habitat restoration unit.

The step 3 further includes displaying the fish information, water body information, and optimal restoration plan by the display unit, for a responsible person to adjust the most expected best restoration plan.

In step 1, the water information management unit includes a collection device and/or an information crawling device; there are a plurality of collection devices, they are respectively provided at different positions in the to-be-restored water area and configured to obtain the water information of the to-be-restored water area; the crawling device obtains the water body information of the to-be-restored water area in the Internet of Things based on name and/or location of the to-be-restored water area; the water body information obtained by the collection device and/or the crawling device includes an overall volume V of the to-be-restored water area, as well as a corresponding water volume, water flow velocity, and water depth at different locations.

The water information management unit divides the to-be-restored water area into a plurality of investigation areas based on the water information, the water volume of every investigation area is different, and is represented by V2. The number of investigation areas is represented by i, i is a positive integer greater than or equal to 1. In an implementation, the water information management unit conducts a regional division on the to-be-restored water area based on the water flow velocity and water depth in the water information; in a same investigation water area, a maximum water flow velocity difference is less than or equal to a first water flow threshold, that is, a difference between a maximum water flow velocity and a minimum water flow velocity is less than or equal to the first water flow threshold; a maximum water depth difference is less than or equal to a first depth threshold, that is, a difference between a maximum water depth and a minimum water depth is less than or equal to the first depth flow threshold. The first water flow threshold and the first depth threshold are preset values, can be set according to an actual situation, or be modify an input unit of the fish habitat water flow structure restoration system. In addition, it should be noted that, if water flow velocity differences in two investigation areas are less than or equal to the first water flow threshold, water depth differences are less than or equal to the first depth threshold, and the two investigation areas are not adjacent, then the two investigation areas are two different investigation areas; and when the two investigation areas are adjacent, the two investigation areas are merged into one investigation area.

In step 2, the aquatic organism investigation unit includes a plurality of shooting devices for sampling aquatic organisms. The shooting devices are provided at different target positions in different investigation areas, and the aquatic organisms at these positions are sampled and shoot so as to obtain the aquatic organism sampling map at a plurality of specified time periods. The aquatic organism investigation unit estimates fish species and fish quantity in the to-be-restored water area at each specified time period based on the aquatic organism sampling map collected by the plurality of shooting devices in a plurality of time periods. The number x of the shooting devices is a multiple of the number i of the investigation areas, the multiple is a first multiple z, and the first multiple z is a positive integer greater than or equal to 2, that is, the number x of shooting devices is z*i.

The shooting devices are provided in each investigation area, and the number of the shooting devices in each investigation area is equal to a value of the first multiple. Shooting position of the shooting device in a same investigation area can be placed at the target position according to the water depth, or placed at the target position according to the water flow velocity. There are no specific requirements here, and the operator can also adjust according to the situation of the to-be-restored water area.

The obtaining fish information in the water body in each specified time period by the aquatic organism investigation unit includes the following steps:
step 21: collecting an aquatic organism sampling map for each target location in each investigation area at a specified time period, by the shooting device of the aquatic organism investigation unit;
step 22: conducting graphical analysis on the aquatic organism sampling map for each specified time period by the aquatic organism investigation unit to obtain fish species and fish quantity in each aquatic organism sampling map;
step 23: obtaining the fish species and fish quantity in each investigation area for each specified time period with a threshold value method, by the aquatic organism investigation unit;
step 24: summing up the number of fish for different species in all investigation areas for each specified time period at each specified time period by the aquatic organism investigation unit, and obtaining a corresponding number of fish for different species in the to-be-restored water area for each specified time period.

In step 21, when each target location in the investigation area is selected according to the water depth, the aquatic organism investigation unit divides the water depth in the current investigation area into a water depth stratifications, and a value of a is equal to the value of the first multiple; depths of the a water depth stratifications are equal to a water depth of the current investigation area; the shooting device in each investigation area is placed at different water depth stratifications corresponding to the current investigation area based on the divided a water depth stratifications and collect the aquatic organism sampling map at the current target location for each specified time period.

When each target location in the investigation area is selected according to the water flow velocity, the aquatic organism investigation unit divides the water flow velocity in the current investigation area into a water flow zones, and a value of a is equal to the value of the first multiple; a flow velocity interval of the a water flow zones is equal to a flow velocity interval of the current investigation area; the shooting device in each investigation area is placed in the water flow zones with different water flow velocities corresponding to the current investigation area based on the divided a water flow zones so as to collect the aquatic sampling map for the current target location for each specified time period.

When providing with the shooting device in the investigation area, a corresponding marker is provided at an investigation area corresponding to each shooting device; the number of the shooting device in each investigation area is z, z is equal to the water depth stratification/water flow zone a of the current investigation area.

The fish habitat water flow structure restoration system is provided with a water volume V1 of the target location for collecting the aquatic organism sampling map when the shooting device collecting the aquatic organism sampling map; the water body information management unit, based on the marker of the shooting device corresponding to each aquatic organism sampling map, reads a volume V2 of the investigation area corresponding to an investigation area where the corresponding shooting device is located.

In step 23, the obtaining the fish species and fish quantity in each investigation area with a threshold value method includes the following:
calculating the number N′ of fish for different species in the current investigation area for each specified time period according to a relationship between the number n of fish for different species at the target location in each investigation area with the water volume V1 of the target location and the water volume V2 of the investigation area, by the aquatic organism investigation unit; and the calculation formula is as follows:

$${N}^{′} = {\sum }_{m = 1}^{z} \frac{V {1}_{m}}{{n}_{m}} * \frac{V 2}{z} .$$

m represents a target location of a N^{th} shooting device in the same investigation area.

The step 24 includes the following substeps:
step 241: calculating a number N of fish for different species in the to-be-restored water area based on the number of fish for different species in all investigation areas for each specified time period, by the aquatic organism investigation unit, and placing the number N of fish for different species in the to-be-restored water area for each specified time period in a sampling set of the aquatic organism investigation unit;
step 242: calculating a number N″ of fish for different species in a future T^{th} time period based on the number N of fish for different species in the to-be-restored water area for each specified time period in the sampling set, by the aquatic organism investigation unit.

The formula for calculating the number N of fish for different species in the to-be-restored water area is as following:

$$N = {\sum }_{k = 1}^{i} {N}_{k}^{′} .$$

K represents a N^{th} investigation area where the same fish species are located.

The habitat selection unit includes restoration plans for habitats corresponding to different fish species, different fish species has restoration plans for the fish species with different numbers. Specifically, the restoration plan includes an optimal restoration area and material for different fish species with different numbers, as well as the water depth and water flow velocity for the habitats corresponding to different fish species.

The step 242 specifically includes:
calculating a value of a first target parameter in a first calculation formula based on the number N of fish for different species in the to-be-restored water area at each specified time period in the sampling set, by the aquatic organism investigation unit;
calculating a value of a second target parameter in a second calculation formula based on the number N of fish for different species in the to-be-restored water area at each specified time period in the sampling set, by the aquatic organism investigation unit;
inputting values of the first target parameter and the second target parameter into a third calculation formula to calculate the number N″ of fish for different species in the further T^{th} time period, by the aquatic organism investigation unit.

The first calculation formula is defined to describe a relationship between the number N of fish for different species in different time periods, and a specific expression is Yₜ=C+φ₁Yₜ₋₁+φ₂Yₜ₋₂+K+φₚYₜ₋ₚ+ξₜ;
Yₜ is an observation value of the number of fish for different species in a time period t, where c is a constant, φ is an autoregressive coefficient, and ξₜ is an error term; the constant c, autoregressive coefficient φ, and error term ξₜ are the first target parameters.

The second calculation formula is defined to describe a relationship between data at a current time point and a past noise, and a specific expression is Yₜ=μ+ξₜ+θ₁εₜ₋₁+θ₂εₜ₋₂+Λ+θ_{q}ε_{t-q};
Yₜ is a time series of interested, and the observation value at the time point t is an observation value of the number of fish for different species at the time period t; μ is a mean or expected value of the time series, which is the same for all time points; θ is a parameter of the second calculation formula, and each parameter θ corresponds to a white noise term, which measures an influence degree of a corresponding white noise on the current time point, εₜ is the white noise term; and the parameter θ and white noise term εₜ are the second target parameters.

The third calculation formula is:

$${Y}_{i} = C + {φ}_{1} {Y}_{t - 1} + {φ}_{2} {Y}_{t - 2} + K + {φ}_{p} {Y}_{t - q} + {ε}_{t} + {θ}_{1} {ε}_{t - 1} + {θ}_{2} {ε}_{t - 2} + Λ + {θ}_{q} {ε}_{t - q} ;$$

Yₜ is the time series of interested, a calculation value at the time point t is an estimated value of the number N″ of fish for different species in the future time period t.

The step 3 specifically includes:
step 31: selecting a restoration plan corresponding to this fish species in the water area from the restoration plan of habitats for different fish species based on the number N″ of fish for different species in the further T^{th} time period, by the habitat selection unit;
step 32: combining the restoration plan corresponding to each fish species to obtain the optimal restoration plan, by the habitat selection unit.

In step 32, the combining the restoration plan corresponding to each fish is to directly place the restoration plan corresponding to each fish in the optimal restoration plan.

In step 4, the habitat restoration unit selects the target water area, i.e., the optimal restoration location, based on the restoration plan corresponding to each fish species in the optimal restoration plan, as well as the water information of the to-be-restored water area or different investigation areas, and adopts the optimal restoration plan to restore the to-be-restored water area in the target water area.

Thus, habitat restoration can be accurately carried out in the to-be-restored water area based on the fish species and fish quantity. This not only avoids the problem of insufficient fish habitat caused by fish reproduction, but also avoids the problem of excessive restoration rang and resource waste.

The above content is an explanation of the preferred embodiments of the present disclosure, which can help those skilled in the art to have a more comprehensive understanding of the technical solution of the present disclosure. However, these embodiments are only examples and cannot be considered as specific embodiments of the present disclosure being limited to the description of these embodiments. For those skilled in the art, without departing from the concept of the present disclosure, several simple deductions and transformations can also be made, which should be considered as falling within the protection scope of the present disclosure.

1. A method for restoring a fish habitat water flow structure, comprising:
obtaining water body information of a target water area and dividing the target water area into a plurality of investigation areas based on the water body information;
for a plurality of time periods, obtaining an aquatic organism sample picture for each of the investigation areas in each of the time periods;
obtaining first fish information of the target water area in the each of the time periods according to the aquatic organism sample picture;
estimating second fish information of the target water area in a future time period based on the first fish information;
generating restoration information for a fish habitat water flow structure in the target water area based on the second fish information and the water body information; and
restoring the fish habitat water flow structure in the target water area according to the restoration information,
wherein obtaining the first fish information of the target water area in the each of the time periods comprises:
for the each of the time periods, obtaining, by applying an image recognition on the aquatic organism sample picture, fish species information and fish quantity information corresponding to the aquatic organism sample picture for the each of the investigation areas; and
obtaining the first fish information of the target water area according to the fish species information and the fish quantity information for the each of the time periods.

2. The method according to claim 1, wherein the water body information comprises an overall volume V of the target water area and water volumes, water flow velocities and water depths at respective positions of the target water area.

3. (canceled)

4. The method according to claim 1, wherein the aquatic organism sample picture is obtained at a target position of the each of the investigation areas according to water depths and/or water flow velocities of respective positions in the each of the investigation areas.

5. The method according to claim 4, wherein;
the each of the investigation areas is divided into a plurality of water depth zones according to water depths of the respective positions in the each of the investigation areas, and each of the water depth zones provided a first position at which the aquatic organism sample picture is obtained; and/or
the each of the investigation areas is divided into a plurality of water flow zones according to water flow velocities of the respective positions in the each of the investigation areas, and each of the water flow zones provided a second position at which the aquatic organism sample picture is obtained.

6. The method according to claim 4, wherein obtaining the first fish information comprises:
obtaining, fish species information and fish quantity information of the each investigation areas according to the fish species information and the fish quantity information corresponding to the aquatic organism sample picture for the each of the investigation areas, a water volume V1 of the target position, and a water volume V2 of the each of the investigation areas; and
obtaining the first fish information according to the fish species information and the fish quantity information of the each investigation areas.

7-8. (canceled)
